(19) United States
(12) Patent Application Publication
(10) Pub. No.: US 2006/0210693 A1
(43) Pub. Date: Sep. 21, 2006

(54) Method for the reduction of acrylamide formation during heating of amino group-containing compounds

(75) Inventors: Alfred Oftring, Bad Durkheim (DE); Klaus Kramer, Bad Sackingen (DE); Brigitte Nowakowsky, Speyer (DE); Ute Obermuller-Jevic, Flein (DE); Arnulf Troscher, Weinheim (DE); Wolf Stegmaier, Bohl-Iggelheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/553,025

(22) PCT Filed: Apr. 7, 2004
(86) PCT No.: PCT/EP04/03692

§ 371 Date: Oct. 11, 2005

(30) Foreign Application Priority Data
Apr. 11, 2003 (DE) 103 16 998.9

(51) Int. Cl. A23L 1/216

(52) U.S. Cl. 426/637

(57) ABSTRACT

A process is described for reducing the formation of acrylamide during the heating of amino compounds in the presence of reducing substances, which comprises, before the heating, mixing the amino compounds with ascorbic acid and/or vitamin E.

The present invention relates to a process for reducing the formation of acrylamide during the heating of amino, compounds in the presence of reducing substances, which comprises, before the heating, mixing the amino compounds with ascorbic acid and/or vitamin E.

The formation of acrylamide as a result of thermal stress of foods, in particular of high-carbohydrate foods such as potato products and cereal products has been a subject of open discussion for some time. Animal experiments disclose that acrylamide can be carcinogenic and, at higher doses, even be neurotoxic.

The mechanisms of acrylamide formation are currently still relatively obscure. However, there is some evidence to indicate that the Maillard reaction between a-amino acids and reducing sugars plays a central part.

In Nature 2002, 419, 448 (D. Mottram et al.), the Maillard reaction and the associated formation of acrylamide are described in more detail on the basis of model experiments. In particular, the reaction of glucose with the amino acid asparagine yields significantly high quantities of acrylamide (>100 mg per mole of amino acid) at high temperatures (for example 180° C.) in a weakly acid-buffered environment.

Similar results have been found by R. H. Stadler et al. (Nature 2002; 419, 449).

In Deutsche Lebensmittel Rundschau, Number 11, 2002, 397ff., R. Weiβhaar and B. Gutsche likewise describe the formation of acrylamide by the thermal decomposition of asparagine in the presence of reducing sugars. As reducing compound, inter alia, ascorbic acid was also used by the authors.

The simultaneous use of amino acid, a reducing sugar and ascorbic acid has not previously been described in the above mentioned prior art.

It was an object of the present invention, then, to decrease significantly the formation of acrylamide during the thermal treatment of amino compounds.

We have found that this object is achieved by the process mentioned at the outset.

For the purposes of the present invention, the term ascorbic acid comprises not only L-ascorbic acid (vitamin C), but also D-ascorbic acid (isoascorbic acid) and also salts and fatty acid esters of the two diastereomeric forms.

Examples of salts of ascorbic acid are alkali metal or alkaline earth metal salts such as sodium ascorbate, potassium ascorbate or calcium ascorbate, but also salts of ascorbic acid with organic amine compounds such as choline ascorbate or L-carnitine ascorbate. Preferably, use is made of alkali metal salts of ascorbic acid, particularly preferably sodium ascorbate.

Fatty acid esters of ascorbic acid are, for example, L-ascorbyl palmitate or L-ascorbyl stearate.

For the purposes of the present invention, the term vitamin E comprises vitamin E, vitamin E derivatives or mixtures thereof. The term vitamin E in this context means natural or synthetic α-, β-, γ- or δ-tocopherol and also tocotrienol. Vitamin E derivatives are, for example, tocopheryl esters of C₁-C₂₀-alkanoic acids, such as tocopheryl acetate or tocopheryl palmitate.

In a preferred embodiment of the inventive process, to reduce the formation of acrylamide, use is made of L-ascorbic acid and also salts thereof, in particular sodium L-ascorbate. The term ascorbic acid or ascorbate therefore means hereinafter the L form.

Amino compounds are, for example, amino acids such as asparagine, glutamine, methionine, cysteine, tryptophan, histidine or lysine, and also proteins which comprise these amino acids. A preferred amino acid is asparagine and preferred proteins are asparagine-containing proteins.

Reducing substances which are suitable for the inventive process are preferably reducing sugars, for example glucose, fructose, mannose, ribose, galactose, lactose, cellobiose or maltose.

A feature of the inventive process is, in addition, that there is a reduction in the formation of acrylamide during the heating of amino compounds at temperatures above 90° C., preferably at temperatures in the range from 120 to 250° C., particularly preferably in the range from 150 to 200° C.

A further preferred embodiment of the inventive process leads to a reduction in the formation of acrylamide during the heating of foods and animal feeds, particularly preferably during the heating of starchy foods, very particularly preferably during the baking, pan-frying, boiling or deep-fat frying of potato- and cereal-containing foods.

Examples of potato- and cereal-containing foods are, inter alia, potato chips, French fries, pan-fried potatoes, potato röstis [potato pancakes], bread, crispbread, rusk, breakfast cereals, cookies and crackers.

Using the inventive process it is possible to reduce the formation of acrylamide by from 60 to 99%, preferably by from 75 to 90%, compared with reaction products without the addition of ascorbic acid and/or vitamin E.

The amount of ascorbic acid and/or vitamin E used is in the range from 5 to 150 mol %, based on the amount of amino compounds.

A particularly preferred embodiment of the inventive process relates to decreasing the formation of acrylamide during the heating of potato- or cereal-containing foods which comprise asparagine or asparagine-containing proteins at temperatures in the range from 150 to 200° C., which comprises, before the heating, adding L-ascorbic acid or sodium L-ascorbate to the foods.

The inventive process will be described in more detail with reference to the following examples.

### EXAMPLE 1

A mixture of 1.32 g (10 mmol) of asparagine and 1.98 g (10 mmol) of glucose monohydrate were heated in 10 g of 0.5 M phosphate buffer (pH 5.5) for 30 minutes at 180° C. in an autoclave. The resultant mixture, according to gas-chromatographic analysis, comprised 133 mg of acrylamide/mole of asparagine.

### EXAMPLE 2

In a similar manner to Example 1, 1.76 g (10 mmol) of ascorbic acid were heated with 1.32 g (10 mmol) of asparagine. 26 mg of acrylamide/mole of asparagine were formed.

### EXAMPLE 3

In a similar manner to Example 1, 1.32 g of asparagine, 1.98 g of glucose monohydrate and 1.76 g of ascorbic acid were heated. 31 mg of acrylamide/mole of asparagine were formed.

### EXAMPLE 4

In a similar manner to Example 1, 1.32 g of asparagine, 1.98 g of glucose monohydrate and 0.88 g (5 mmol) of ascorbic acid were heated. 36 mg of acrylamide/mole of asparagine were formed.

### EXAMPLE 5

Decrease in acrylamide formation in the production of baked cookies using ascorbic acid
a. 85 parts of a prepared cookie dough mix (Greens “Ready to Mix Cookies”) having an asparagine content of 1.4 mg/g of ready-to-mix dough were admixed with 15 parts of water and kneaded. The dough was then rolled out to a thickness of approx. 0.5 cm and 6 portions having a diameter of approx. 7 cm were stamped out therefrom.
b. In a similar manner to 5a., a further 6 portions of a second cookie dough were produced which were additionally admixed with 7 mg of ascorbic acid per g of prepared dough mix.

All 12 samples were baked at 190° C. for 12.5 minutes.

After the baking process, the samples were analyzed for their acrylamide content. The values given in the following table clearly show the decreased acrylamide formation during baking of a cookie dough which had been enriched with ascorbic acid before the baking process.

| | Acrylamide content [μg/kg of baked good] | | |
|---|---|---|---|
| | Sample A | Sample B | Sample C |
| Baked cookie without | 66 μg/kg | 89 μg/kg | 100 μg/kg |
| vitamin C | | | |
| Baked cookie with | 19 μg/kg | 45 μg/kg | 56 μg/kg |
| vitamin C | | | |

### EXAMPLE 6

Decrease of acrylamide formation in the deep-frying of potato cakes using ascorbic acid
a. 22 parts of dried water-free potato flakes having an asparagine content of 12.9 mg/g of potato flakes (vico S. A. “Mr. Mash Real Potato Flakes”) were admixed with 78 parts of boiling water and allowed to stand for a short time. Three portions of the resultant potato dough, each of 30 grams, were deep-fried at 185° C. in sunflower oil for 6.5 minutes.
b. In a similar manner to 6a., a further 3 portions of a second potato dough were produced which were additionally admixed with 65 mg of ascorbic acid per g of potato flakes used.

After the deep frying, all samples were analyzed for their acrylamide content. The values given in the table below clearly show the decreased acrylamide formation in the deep frying of a potato dough which had been enriched with ascorbic acid.

| | Acrylamide content [μg/kg of baked good] | | |
|---|---|---|---|
| | Sample A | Sample B | Sample C |
| Potato balls without | 954 μg/kg | 1428 μg/kg | 1095 μg/kg |
| vitamin C | | | |
| Potato balls with | 346 μg/kg | 307 μg/kg | 424 μg/kg |
| vitamin C | | | |

1. A process for reducing the formation of acrylamide during the heating of amino compounds in the presence of reducing substances, which comprises, before the heating, mixing the amino compounds with ascorbic acid and/or vitamin E.

2. A process as claimed in claim 1, wherein the amino compounds are heated in the presence of reducing sugars.

3. A process as claimed in claim 1, wherein the amino compounds are amino acids or proteins.

4. A process as claimed in claim 3 for reducing the formation of acrylamide during the heating of asparagine or asparagine-containing proteins.

5. A process as claimed in claim 1 for reducing the formation of acrylamide at temperatures above 90° C.

6. A process as claimed in claim 5 at temperatures in the range from 120 to 250° C.

7. A process as claimed in claim 1 for reducing the formation of acrylamide during the heating of foods and animal feeds.

8. A process as claimed in claim 7 in the heating of starchy foods.

9. A process as claimed in claim 8 for reducing the formation of acrylamide during the baking, pan-frying, boiling or deep-fat frying of potato- and cereal-containing foods.

10. A process as claimed in claim 1, wherein the formation of acrylamide is reduced by from 60 to 99%.

11. A process as claimed in any of claims 1 to 10, which comprises, before the heating, the amino compounds mixing with L-ascorbic acid or sodium L-ascorbate.

12. A process as claimed in claim 5 at temperatures in the range from 150 to 200° C.

13. A process as claimed in claim 1, wherein the formation of acrylamide is reduced by from 75 to 90%.
